(19) United States
(12) Patent Application Publication
(10) Pub. No.: US 2013/0268121 A1
(43) Pub. Date: Oct. 10, 2013

(54) Apparatus For The Development And Operation Of At Least One Mechatronic Installation, Which Exhibits Mechatronic Units

(71) Applicant: SIEMENS AKTIENGESELLSCHAFT, Munchen (DE)

(72) Inventors: Birthe Bohm, Nurnberg (DE); Norbert Gewald, Ismaning (DE)

(73) Assignee: Siemens Aktiengesellschaft, Munchen (DE)

(21) Appl. No.: 13/856,147

(22) Filed: Apr. 3, 2013

(30) Foreign Application Priority Data
Apr. 5, 2012 (DE) 102012205685.8

(51) Int. Cl. G05B 15/02

(52) U.S. Cl. CPC G05B 15/02
USPC 700/275

(57) ABSTRACT

An apparatus for development and operation of a mechatronic installation that exhibits mechatronic units, with a data memory storing interdisciplinary mechatronic object data relating to mechatronic units, a communications interface for connecting the apparatus to at least one data network, and a control facility embodied to (a) identify at least one additional service relating to at least one of the mechatronic units of the mechatronic installation by an identification of the mechatronic unit stored in the interdisciplinary mechatronic object data, and, (b) in a development and/or maintenance step and/or during the control of the mechatronic installation, to load program code corresponding to a respective service into the data memory and carry it out locally and/or to call up at least one of the identified services by way of a protocol for the inter-process communication, e.g. RPC, and/or by way of an application interface, e.g., a REST and/or SOAP application interface.

### CROSS-REFERENCE TO RELATED APPLICATIONS

This application claims priority to DE Patent Application No. 10 2012 205 685.8 filed Apr. 5, 2012. The contents of which is incorporated herein by reference in its entirety.

### TECHNICAL FIELD

The present disclosure relates to an apparatus for the development and operation of at least one mechatronic installation, which exhibits mechatronic units. The present disclosure further relates to a corresponding method.

### BACKGROUND

Mechatronics are concerned in an interdisciplinary manner with the interaction of mechanical, electronic, and information technology units in mechatronic installations.

In mechatronics, mechanics, electronics, and informatics are merged with one another, and, instead of or in addition to several models, they describe one overall mechatronic system, the mechatronic installation. That is to say, even with the introduction of an overall mechatronic system, several models may exist, which are then combined in a suitable manner (for example, this can be done by way of the definition of a mechatronic model and the pure linking of this model to the discipline-specific models, i.e. the discipline-specific model is not replaced, but only supplemented by a mechatronic model. Mechatronic installations have the function of resolving a given technical problem using sensors, processors, actuators and elements from mechanics, electronics, and informatics, etc.

Mechatronic installations resolve the given problem in that they link mechatronic units in a suitable manner. The term “mechatronic units” is used in general to designate the individual component parts of a mechatronic installation.

Mechatronic installations are used today in many applications. Possible application situations for mechatronic installations are, for example, production systems and power station technology, such as in control systems of a power station for instance.

Modern mechatronic installations may in this situation exhibit a plurality of mechatronic units. Mechatronic units may in this situation be, for example, servo motors or electric valves, but also aggregated mechatronic units which include other mechatronic units, such as, for example, conveyor units, sorting systems, and the like. In complex applications, in this situation, the number of individual mechatronic units may be very high; for example, mechatronic installations are possible which exhibit well over 1000 mechatronic units.

In order to be able to produce complex mechatronic installations, an elaborate development method is necessary. In this development method a mechatronic installation is first planned and, if appropriate, simulated. Only when a simulation of the mechatronic installation is successfully running will the mechatronic installation be set up and tested.

In the development of mechatronic installations it is usual to make use of a plurality of different development tools. In this situation, the respective development tools are usually adapted to the different disciplines. For example, development tools exist for the planning or, respectively, the simulation of the electronics of a mechatronic installation, development tools for the planning or, respectively, the simulation of the hydraulics of a mechatronic installation, development tools for the mechanical or, respectively, spatial planning or, respectively, simulation of a mechatronic installation, development tools for the thermal planning or, respectively, simulation of a mechatronic installation, and the like.

Each development tool in this situation provides its own database, in which the data relating to the individual mechatronic units is stored which is necessary for the respective development tool. In this situation, the data relating to the individual mechatronic units is administered and maintained locally in the respective development tools. Changes to the data relating to a mechatronic unit in a development tool do not usually have an effect on the data which is stored in other development tools relating to the respective mechatronic unit. Cross-relating tools today only exist in part, or usually do not cover all the working items or special requirements of a domain. Moreover, it is not possible for the functionality of the development tools to be adapted in relation to individual mechatronic units.

### SUMMARY

One embodiment provides an apparatus for the development and operation of at least one mechatronic installation, which exhibits mechatronic units, with: a data memory, which is embodied such as to store interdisciplinary mechatronic object data relating to mechatronic units; a communications interface for connecting the apparatus to at least one data network; and with a control facility, which is embodied (a) to identify at least one additional service relating to at least one of the mechatronic units of the mechatronic installation by means of an identification of the mechatronic unit stored in the interdisciplinary mechatronic object data, and (b) in a development step and/or a maintenance step and/or during the control of the mechatronic installation, to load the program code corresponding to a respective service into the data memory and implement it locally and/or to call up at least one of the identified services by way of a protocol for the inter-process communication, in particular RPC, and/or by way of an application interface, in particular a REST application interface and/or a SOAP application interface.

In a further embodiment, at least one server facility is provided, which is embodied to provide by way of the data network the additional services, wherein, in particular, at least one server facility is designed as a central server facility, which is designed to provide a schedule of the additional services.

In a further embodiment, at least one of the server facilities is embodied to bill for the provision of the additional services by way of a billing system.

In a further embodiment, the additional services relating to the mechatronic units of the mechatronic installation exhibit services which are embodied to support a development step and/or the maintenance and/or the control of the mechatronic installation.

In a further embodiment, a user interface is provided, which is embodied to provide a user with a list of the available additional services and/or to allow a user to make a selection of additional services.

In a further embodiment, the control facility is embodied to call up additional services selected by a user by way of the communications interface.

Another embodiment provides a method for the development and operation of at least one mechatronic installation, which exhibits mechatronic units, with the steps: storage of interdisciplinary mechatronic object data relating to the mechatronic units of the mechatronic installation; identification of at least one additional service relating to at least one of the mechatronic units of the mechatronic installation by way of an identification of the mechatronic unit, stored in the interdisciplinary mechatronic object data; and carrying out the identified services in a development step and/or a maintenance step and/or during the control of the mechatronic installation, wherein the program code corresponding to a respective service is stored and carried out locally, and/or wherein at least one of the identified services is carried out by way of a protocol for the inter-process communication, in particular RPC, and/or by way of an application interface, in particular a REST application interface and/or a SOAP application interface.

In a further embodiment, the additional services (5-1-5-4) are provided on at least one server facility in the data network.

In a further embodiment, a schedule of the additional services is provided on a server in the data network.

In a further embodiment, the provision of the additional services is billed by way of a billing system.

In a further embodiment, the additional services relating to the mechatronic units of the mechatronic installation exhibit services which support a development step of the mechatronic installation or the maintenance and/or the control of the mechatronic installation.

In a further embodiment, a user is provided with a list of the additional services and/or the user is able to make a selection of additional services.

In a further embodiment, the additional services selected by a user are called up by way of the data network.

### BRIEF DESCRIPTION OF THE DRAWINGS

Exemplary embodiments will be explained in more detail below based on the schematic drawings, wherein:

FIG. 1 shows a block diagram of an embodiment of an apparatus 1 according to one embodiment;

FIG. 2 shows a flow diagram of an embodiment of a method according to one embodiment;

FIG. 3 shows a block diagram of a further embodiment of an apparatus 1 according to one embodiment;

FIG. 4 shows a block diagram of a further embodiment of an apparatus 1 according to one embodiment.

### DETAILED DESCRIPTION

Embodiments of the present disclosure provide a possibility for mechatronic installations to be developed and operated simply and efficiently.

Provision is therefore made for:

An apparatus for the development and operation of at least one mechatronic installation, which exhibits mechatronic units, with a data memory, which is designed to store interdisciplinary mechatronic object data relating to mechatronic units, a communication interface for connecting the apparatus to at least one data network, and with a control facility, which is embodied to identify at least one additional service relating to at least one of the mechatronic units of the mechatronic installation by means of an identification of the mechatronic unit, stored in the interdisciplinary mechatronic object data, and, in a development step and/or a maintenance step and/or when controlling the mechatronic installation, to load the program code corresponding to the respective service into the data memory and implement it locally, and/or to call up at least one of the identified services by way of a protocol for the inter-process communication, in particular RPC, and/or by means of an application interface, in particular a REST application interface, and/or a SOAP application interface.

Provision is further made for:

A method for the development and operation of a mechatronic installation, which exhibits mechatronic units, with the steps of storage of interdisciplinary mechatronic object data relating to the mechatronic units of the mechatronic installation, identification of at least one additional service relating to at least one of the mechatronic units of the mechatronic installation by means of an identification of the mechatronic unit stored in the interdisciplinary mechatronic object data, carrying out the identified services in a development step and/or a maintenance step and/or when controlling the mechatronic installation, wherein the program code corresponding to the respective service is stored and implemented locally and/or wherein at least one of the identified services is implemented by means of a protocol for the inter-process communication, in particular RPC, and/or by way of an application interface, in particular a REST application interface and/or a SOAP application interface.

The knowledge underlying the present disclosure includes the fact that the holding of interdisciplinary mechatronic object data in individual development tools is inflexible, and renders an extension of the development tools difficult.

The present disclosure now consists of taking account of this knowledge and of making provision for a possibility of being able to provide additional services for mechatronic units. In this situation, the present disclosure provides a possibility of identifying mechatronic units on the basis of the interdisciplinary mechatronic object data allocated to a respective mechatronic unit, and, based on this identification, carrying out an additional service for the corresponding mechatronic object. In this situation, the respective additional services support a development step, a maintenance step, and, respectively, the control of the mechatronic installation.

Additional services may be, for example, special, perhaps rarely needed, simulations relating to a mechatronic unit. Additional services may, however, also be services which were originally stored in the interdisciplinary mechatronic object data or directly in the respective development tools, maintenance tools, control installations, or the like. If such services are removed from the interdisciplinary mechatronic object data and made accessible by way of the identification of the mechatronic unit belonging to the interdisciplinary mechatronic object data, then interdisciplinary mechatronic object data can be carried out very economically with regard to the storage requirement.

The present disclosure further provides different possibilities for carrying out the additional services. One possibility includes downloading the program code belonging to a service into the data memory, and implementing the downloaded program code of the service locally in the control facility. This procedure has the advantage that, in order to carry out a service which is often used, a transfer of data by way of the data network is not required every time, and the service is therefore available more rapidly. As well as this, additional functions can be provided as required.

A further possibility includes calling up a service by means of a protocol for inter-process communication. A protocol for inter-process communication makes provision for the information necessary for the carrying out of the additional service to be transferred jointly with the call-up of the service by way of the data network. With this information, the necessary calculations are thereupon carried out, and the result is transferred by way of the data network back to the disclosed apparatus. As protocols for the inter-process communication, a plurality of protocols can be used. For example, RPC (Remote Procedure Call), REST (Representational State Transfer), SOAP (Simple Object Access Protocol) or the like may be used. This is of advantage in particular with very calculation-intensive services, since, as a result, the calculation capacity of the control apparatus of the disclosed apparatus is not burdened by the carrying out of the respective service.

The term “additional services” is to be understood within the framework of this patent application not as a restriction to specific additional services. The term “additional services” is intended only to make it clear that the services are not originally deposited in the interdisciplinary mechatronic object data. If a set of interdisciplinary mechatronic object data relating to a mechatronic unit does not refer to its own services, then the “additional services” are the only services which are provided in connection with the respective interdisciplinary mechatronic object data. Thus, for example, all the services of a set of interdisciplinary mechatronic object data are also provided in some embodiments.

Further, the terms “development step” and “maintenance step” are to be understood such that all the steps in the life cycle of a mechatronic installation are included/of the MO are covered. These may also be, for example, the commissioning, the modernization, and the like.

The “identification” of the mechatronic unit can in this situation be any form of data which makes it possible for a mechatronic unit to be identified, in the sense of the allocation to a service. This can be carried out, for example, by the type of the interdisciplinary mechatronic object data (for example, diagnosis for any kinds of motor, or for a specific type of motor). As an alternative, a service may be found by way of a discipline specific identifier/type. As an alternative, a suitable service may also be carried out individually for a set of interdisciplinary mechatronic object data.

Advantageous embodiments and further developments are derived from the sub-claims as well as from the description, making reference to the figures.

In an embodiment, provision is made for at least one server facility, which is embodied to provide the additional services by way of the data network, wherein, in particular, a server facility is designed as a central server facility, which is embodied to provide a schedule of the additional services. If the additional services are provided centrally on a server facility, simple maintenance and administration of the additional services becomes possible. If the services are provided on a plurality of server facilities, then, for example, every manufacturer of mechatronic units who offers an additional service can administer this on his own server. Moreover, the provision of a schedule of the available additional services allows for the rapid finding of the individual services. The server facilities may, in this situation, be embodied as central server facilities. In a further embodiment, the server facilities may be implemented as decentralized server facilities, e.g. as distributed network memories, as online memories, as what is referred to as a “private cloud”, or as a publicly available “Cloud”, e.g. Google App-Engine.

In an embodiment, at least one of the server facilities is embodied such as to carry out the billing for the provision of the additional services by means of a billing system. This allows for different payment possibilities to be offered for the additional services. For example, a user may license specific additional services for a specific period of time. Moreover, a provider of additional services may bill for each use of one of the additional services, referred to as “pay-per-use”. In the final analysis, a large number of further licensing models are also possible.

In an embodiment, the additional services relating to the mechatronic units of the mechatronic installation exhibit services which are embodied to support a development step or the maintenance of the mechatronic installation. The additional services may, for example, exhibit simulations. The additional services may, however, also exhibit control algorithms or provide support in the maintenance of a mechatronic installation, fault locating in a mechatronic installation, new, more efficient control algorithms for a mechatronic unit of the mechatronic installation, or the like. As a result of this, the development too, like the maintenance, repair, or control of the installation, can be optimized.

In an embodiment, provision is made for a user interface, which is embodied to provide a user with a list of the available additional services, and/or to allow a user to make a selection of additional services. If it is made possible for a user to make a selection of the additional services which are to be carried out, then the additional services can be used in a manner specific to the situation and depending on the application.

In a further embodiment, at least one of the additional services is carried out automatically by the control apparatus. For example, additional services may exhibit an identifier, which identifies these as updates of an existing service. In such a case, the control apparatus can automatically implement the updated version of the service, instead of the service which is already present in the apparatus and/or in a development tool, maintenance tool, or a controller of the mechatronic installation.

In an embodiment, the control facility is designed in such a way as to call up the additional services selected by a user by way of the communications interface. This allows for a flexible response to the input by the user.

In an embodiment, called-up additional services are made permanently available locally after the first implementation in the control facility.

In an embodiment provision is made for interdisciplinary mechatronic object data relating to individual mechatronic units to be updated. To do this, for example, an updating service may be provided for, which makes it possible for individual interdisciplinary mechatronic object data relating to individual mechatronic units to be updated individually. In this situation, in an embodiment it can be assured that the functionality and the interfaces of the previous interdisciplinary mechatronic object data relating to individual mechatronic units remains retained, and only extensions of the interdisciplinary mechatronic object data relating to individual mechatronic units are put into effect by way of additional interfaces and/or additional services. Moreover, information relating to services for interdisciplinary mechatronic object data relating to individual mechatronic units can be enriched by information relating to an implicitly used service of the interdisciplinary mechatronic object data relating to individual mechatronic units. If a mechatronic object is used at cyclical intervals, then it is possible, for example, for a check to be carried out, by a user or by the disclosed apparatus, on the updated status of the interdisciplinary mechatronic object data relating to individual mechatronic units, and for the information relating to services of the interdisciplinary mechatronic object data relating to individual mechatronic units to be supplemented dynamically. This allows to user to call up the latest updated services, as well as allowing for continuous upkeep of the services by the provider of the respective individual service.

The embodiments and further developments referred to heretofore can, inasmuch as is reasonable, be combined with one another as desired. Further possible embodiments, developments, and implementations also encompass not explicitly cited combinations of features described heretofore or hereinafter with regard to the exemplary embodiments. In particular, in this situation the person skilled in the art will also add individual aspects as improvements or supplements to the respective basic form of the present invention.

Embodiments disclosed herein offer a service provider the possibility of providing services which can be extended or modified at any time. Depending on the implementation of the call-up of these services, a continuous upkeep of existing services is possible. In addition, services from external service providers can also be provided, such as, for example, special simulations which do not fall within the scope of interest of the provider of the interdisciplinary mechatronic object data. For additional services, for example, a payment model can be implemented, such that the user of the interdisciplinary mechatronic object data must pay the fixed price for every use of a service (pay per use), or pay a one-off fixed price. The provider of the interdisciplinary mechatronic object data can therefore function as a broker of services for the interdisciplinary mechatronic object data, and establish himself as a central contact point, as well as participating financially in the services offered.

In an embodiment, the provider of the interdisciplinary mechatronic object data may identify external services, such that the user is informed of their origin.

The essential added-value for the user of the interdisciplinary mechatronic object data is the bundling of all the services relating to individual interdisciplinary mechatronic object data in one central information source. The provider of the interdisciplinary mechatronic object data may, for example, also make use of statistics relating to the use of the services for the further orientation and upkeep of his own offer.

In an embodiment, users of the services can additionally evaluate and comment on the individual services.

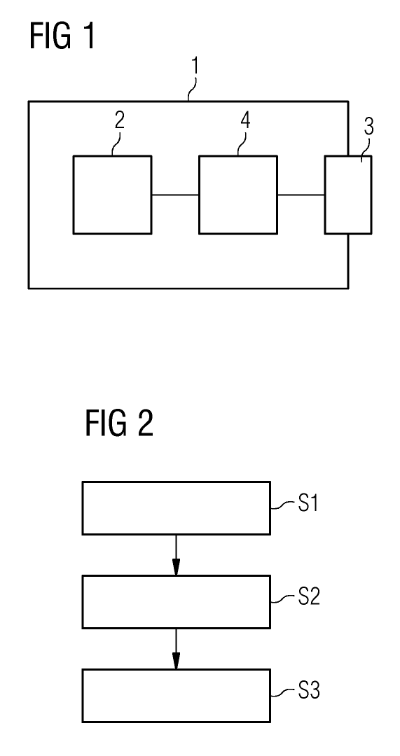

FIG. 1 shows a block diagram of an embodiment of an apparatus 1 according to one embodiment.

The apparatus 1 in FIG. 1 exhibits a data memory 2, which is connected to a control facility 4. The control facility 4 is further connected to a communications interface 3 of the apparatus 1.

Stored in the data memory 2 of the apparatus 1 is interdisciplinary mechatronic object data 8-1 to 8-5 relating to at least one mechatronic unit of the mechatronic installation. In order to carry out one of the additional services 5-1-5-4, the control apparatus 4 calls up, by way of the communications interface 3, one of the additional services 5-1-5-4 by way of the data network 9.

In an embodiment, the apparatus 1 is integrated into a development tool, a maintenance tool, and/or a controller of the mechatronic installation, for example as a plug-in. In a further embodiment, the apparatus 1 is embodied as a network server, and transfers a link to one of the additional services 5-1-5-4, for example by way of the data network 9, to a development tool, a maintenance tool, and/or a controller of the mechatronic installation. In further embodiments, the apparatus 1 does not transfer any link to a development tool, a maintenance tool, and/or a controller of the mechatronic installation, but instead carries out one of the additional services 5-1-5-4, and transfers the results of this action to a development tool, a maintenance tool, and/or a controller of the mechatronic installation.

The data memory 2 in FIG. 1 is designed as a hard disk memory 2. In further embodiments the data memory 2 can be designed as any desired electronic memory. For example, the data memory 2 can be designed as a RAM memory, as an (E)EPROM memory, as an optical memory, or the like.

The control facility 4 in FIG. 1 is designed as a micro-controller. In further embodiments the control facility 4 is designed as a processor, as a microprocessor, as an application-specific integrated circuit (ASIC), or the like.

In FIG. 1 the communications interface 3 is embodied as an Ethernet interface 3. In a further embodiment, the communications interface 3 can be designed as a wireless LAN interface 3, as a WiFi interface 3, as a WiMAX interface 3, as an optical cable-bound interface 3, as an optical cable-less interface 3, or the like.

In a further embodiment, the apparatus 1 is designed as a conventional commercial PC. In another embodiment, the apparatus 1 is designed as a computer program product 1, and is implemented on a conventional commercial PC, a workstation PC, or a server PC.

FIG. 2 shows a flow diagram of an embodiment of a method according to one embodiment.

The method shown in FIG. 2 exhibits a first step S1, in which interdisciplinary mechatronic object data 8-1-8-5 relating to the mechatronic units of the mechatronic installation is stored.

In a second step S2, at least one additional service 5-1-5-4 relating to at least one of the mechatronic units of the mechatronic installation is identified by means of an identification of the mechatronic unit stored in the interdisciplinary mechatronic object data 8-1-8-5.

Finally, in a last step S3, the identified services 5-1-5-4 are carried out in a development step and/or a maintenance step and/or when controlling the mechatronic installation. In this situation the program code which corresponds to a respective service 5-1-5-4 is stored and locally implemented. Additionally or alternatively, at least one of the identified services is carried out by way of a protocol for the inter-process communication, in particular RPC, and/or by way of an application interface, in particular a REST application inter-face and/or a SOAP application interface.

The designation of the steps by the references S1-S3 does not specify any particular sequence for the steps. In further embodiments, the implementation sequence may therefore deviate from the sequence described here.

In further embodiments, the performance of the additional services 5-1-5-4 may be billed by means of a billing system.

In still further embodiments, additional services 5-1-5-4 may be selected by a user and then implemented. Additionally or alternatively, in some embodiments additional services 5-1-5-4 can be implemented automatically. In this situation, the additional services 5-1-5-4 may be implemented instead of the services 5-1-5-4 already present in the interdisciplinary mechatronic object data. To do this, the apparatus 1, in particular the control apparatus 4, checks whether updated versions of the individual services 5-1-5-4 are present in the data network 9, and implements the updated services instead of the services already present.

In still further embodiments, cyclical services can also be carried out in an automated manner, which are linked, for example, to maintenance intervals or operating hours.

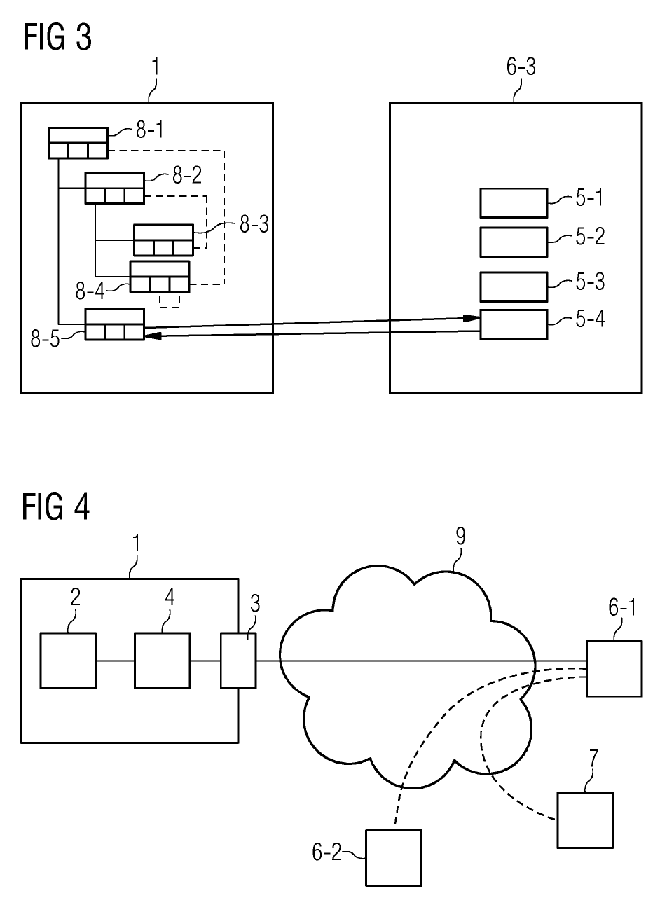

FIG. 3 shows a block diagram of a further embodiment of an apparatus 1 according to one embodiment.

For the purpose of illustration, the apparatus 1 in FIG. 3 exhibits only five blocks 8-1-8-5, which represent interdisciplinary mechatronic object data 8-1 to 8-5. Each of the blocks 8-1-8-5 in this situation exhibits a field with general information relating to a mechatronic unit and, for example, in each case three fields with discipline-specific information relating to the respective mechatronic unit. The discipline-specific information items may relate, for example, to electronics, mechanics, hydraulics, geometry, thermics or the like, and also in different combinations. General information may, for example, exhibit the designation, identification numbers, manufacturer's details, or the like, relating to a mechatronic unit.

In FIG. 3, the block 8-1 forms the superordinated block for the blocks 8-2 and 8-5, which are connected to this in each case, represented by continuous black lines. Finally, the block 8-2, likewise represented by continuous black lines, is linked to the blocks 8-3 and 8-4 subordinated to it.

Represented by broken lines are relationships between the blocks 8-1 and 8-4, 8-2 and 8-3, and between two facets of the block 8-4.

Relationships represent in this situation the dependencies between the data contents of facets and general information or also on the object level, in all permutations. Such dependencies additionally exist in respect of the hierarchical structuring of the mechatronic object data already described. Dependencies may pertain between data A with other data B, wherein, for example, the data A can be derived from the data B, between redundant data, which, for example for performance reasons, is held several times over, between data items which supplement one another (e.g. additional information), or in order to formulate additional relationships between data or facets or mechatronic object data (e.g. the introduction of further structurings of the mechatronic object, for example due to further hierarchies of the disciplines, predecessor-successors in the method). Relationships accordingly serve as indicators or also for securing consistency. The hierarchical mechatronic object structure, by contrast, represents the breaking down of the MOs in a consists-of relationship.

In an embodiment, the superordinated block 8-1 represents the interdisciplinary mechatronic object data 8-1 of a mechatronic installation. The blocks 8-2 and 8-5, subordinated on the first level, represent in this situation the interdisciplinary mechatronic object data 8-2 and 8-5 of two components of the mechatronic installation, such as, for example, two conveyors. Finally, the blocks 8-3 and 8-4, subordinated to the block 8-2, represent the interdisciplinary mechatronic object data 8-3 and 8-4 of the components of the conveyor. These may be, for example, a motor and a sensor.

In further embodiments, the blocks 8-1 to 8-5 represent the interdisciplinary mechatronic object data 8-1 to 8-5 of other components of mechatronic installations.

In further embodiments, blocks may also follow other structuring criteria; for example, blocks may also contain method steps with the components allocated to them.

In FIG. 3 a server facility 6-3 is further represented, which exhibits four additional services 5-1 to 5-4.

Finally, a first arrow, which points from the block 8-5 to the service 5-4, indicates that the apparatus 1 carries out the service 5-4 as an additional service to the interdisciplinary mechatronic object data 8-5. Further, an arrow running back from the service 5-4 to the block 8-5 indicates that the server 6-3 transfers the results deriving from the performance of the service to the apparatus 1. In the foregoing example, the service 5-4 would relate to a conveyor. In further exemplary embodiments, the service 5-4 relates to any desired mechatronic units.

In further embodiments, the results which are delivered back may, for example, also be deposited in a file, and, as a result of the service, reference may be given to this file, or the service updates information which is already present (such as parts lists which are not contained in the current MO), and issues back only a status notification (e.g. “dealt with”), or no value, or the service updates the data of the MO itself in the general information, the facets etc. (for example, if the service undertakes an optimization of the parameterization or checks for consistency).

Additional services may be, for example: Additional diagnosis possibilities for the MO, preparation of evaluations on the basis of MO information, simulations for the MO. If additional diagnosis possibilities for the MO are called up, the service can, for example, interrogate and analyze the values currently available in the MO, and draw conclusions on the basis of a knowledge databank, with regard, for example, to necessary maintenance steps, wear status, consistency of the parameterization. These conclusions can then be transferred, for example in the form of a text or a presentable text (e.g. by HTML), to the calling-up MO, and can be represented to the user in the appropriate manner, or deposited in the MO as diagnosis information. As a further example, a thermal simulation for an MO can be carried out by an additional service. To do this, information is provided to the service with regard to the state of the MO (geometry, material etc.), as well as with regard to the surrounding environment (if appropriate by way of linked MO's) (e.g. as parameterization at the call-up of the service). This information is then used by the simulation service for the calculation of the thermal properties of the MO, and the results of the simulation are finally displayed to the user or again deposited in the MO as the result of the service. If appropriate, the service can adjust the parameterization of the MO, in order to optimize the thermal behavior. Results in this context may be, for example: Data sets, visualization etc.).

FIG. 4 shows a block diagram of a further embodiment of an apparatus 1 according to one embodiment.

The apparatus 1 in FIG. 4 corresponds to the apparatus 1 from FIG. 1. Further, the apparatus 1 is connected by way of the communication interface 3 and a data network 9 to a server facility 6-1.

Finally, represented by broken lines, a second server facility 6-2 and a billing system 7 are connected to the server facility 6-1.

In FIG. 4 the server facility 6-1 is designed in such a way that it provides a schedule of the additional services 5-1-5-4. In order to be able to provide this schedule, the server facility 6-2 transfers to the server facility 6-1, by way of the data network 9, a list of the additional services 5-1-5-4 provided by the server facility 6-2.

In further embodiments, a plurality of server facilities 6-2 are connected to the server facility 6-1. In this situation, each server facility 6-2 of the plurality of server facilities 6-2 provides the server facility 6-1 with a list of the services 5-1-5-4 provided by the respective server facility 6-2. It is also possible for several server facilities 6-1 to exist, i.e., for example, competing/supplementing schedule services (e.g. “special schedule” for simulations from simulation providers, special engineering solutions from engineering suppliers). Moreover, “cascading” solutions may also be used; that is to say, if the corresponding data or services respectively are not available locally, then a search is made externally on further server facilities 6-1 (for example, a local use may be free of charge, while a use of external data or services is subject to costs). Further, special providers are questioned first, and then generalized solutions are sought (e.g. in the simulation range).

If one of the additional services 5-1-5-4 is carried out by the apparatus 1, then the apparatus 1 calls up the corresponding additional service 5-1-5-4 directly from that server facility 6-2 which offers this service. To do this, the apparatus 1 requests from the server facility 6-1 the network address of the corresponding server facility 6-2 which provides the additional service 5-1-5-4, and thereupon connects by way of the data network 9 directly with this server facility 6-2. It is also possible in an embodiment for a “tunneling” method to be carried out, i.e. the server facility 6-1 forwards the enquiry directly to the server facility 6-2, and functions as distributor.

In an embodiment, the apparatus 1 downloads the program code belonging to an additional service 5-1-5-4, and implements this in the control apparatus 4. In a further embodiment, the apparatus 1 transfer to the corresponding server facility 6-2 the information necessary for carrying out the additional services 5-1-5-4, and receives from the corresponding server facility 6-2, after this has carried out all the calculations necessary for carrying out the additional service 5-1-5-4, the results of the calculations.

The billing system 7 can be embodied as a separate billing server 7. In further embodiments, the billing system 7 may be integrated into one of the server facilities 6-1, 6-2. In order to be able to bill for the use of a service, at least one server facility 6-1, 6-2, in particular that server facility 6-1 which provides the list of the available additional services 5-1-5-4, stores billing information relating to each additional service 5-1-5-4.

If one of the additional services is called up, the server facility 6-1, 6-2, which stores the billing information relating to the respective service, transfers the stored billing information, together with an identification of the apparatus 1 and/or of the user of the apparatus 1 and/or of the mechatronic object data, to the billing system 7.

The data network 9 is represented in FIG. 4 as a cloud 9. Such a data network 9 may be, for example, a company data network 9, for example an Ethernet-based company data network 9. In such an embodiment the server facilities 6-1, 6-2 server facilities 6-1, 6-2 may be in a computer center of the company data network 9. In still further embodiments, the data network 9 is the Internet 9, and the server facilities 6-1, 6-2 are decentrally-arranged server facilities 6-1, 6-2, which are located in computer centers of the respective providers of the additional services 5-1-5-4. The server facilities 6-1, 6-2 provide, as well as the additional services 5-1-5-4, the appropriate interfaces for calling up the additional services 5-1-5-4 and for sending back the results. In this way, in one embodiment, the server facilities 6-1, 6-2 offer the possibility of allocating the additional services 5-1-5-4 to the corresponding interdisciplinary mechatronic object data 8-1 to 8-5. As a result of this, the correct additional services 5-1-5-4 are always provided for a set of interdisciplinary mechatronic object data 8-1 to 8-5. In an embodiment, in addition to the calling up of one of the additional services 5-1-5-4 and the transfer of the results, a further communication can also take place.

In still another embodiment, the data network 9 can be a virtual private data network (VPN) 9, which connects branches of a company which are located remotely from one another by way of the Internet 9. Other network architectures are likewise possible.

In an embodiment, the additional services 5-1-5-4 are integrated into the interdisciplinary mechatronic object data 8-1 to 8-5 in the form, for example, of links. In this situation, the links are integrated into the interdisciplinary mechatronic object data 8-1 to 8-5 in such a way that no further changes to the interdisciplinary mechatronic object data 8-1 to 8-5 are necessary. In this situation, the additional services 5-1-5-4 are allocated directly to a set of interdisciplinary mechatronic object data 8-1 to 8-5 and/or the services can be allocated to a facet contained in the set of interdisciplinary mechatronic object data 8-1 to 8-5. In an embodiment, in this situation, an additional service is represented to a user as a short designation, possibly with a description, in conjunction with the corresponding link. In addition, further information, such as a detailed documentation or an assessment of one of the additional services 5-1-5-4, is provided. In this situation, the additional services 5-1-5-4 must exhibit an unambiguous designation and/or an unambiguous link.

In an embodiment, parameters which are necessary for the carrying out of one of the additional services 5-1-5-4, are transferred at the call-up of the services. To do this, an interface to the corresponding service of the additional services 5-1-5-4 is defined, which defines the necessary information. The service can then be carried out on one of the server facilities 6-1, 6-2, or the service can be carried out locally in the system which exhibits the interdisciplinary mechatronic object data 8-1 to 8-5.

In an embodiment, the results of the performance of one of the additional services 5-1-5-4 are displayed as external information relating to a set of interdisciplinary mechatronic object data 8-1 to 8-5. In a further embodiment, the results of a performance of one of the additional services 5-1-5-4 are integrated into the set of interdisciplinary mechatronic object data 8-1 to 8-5. In this situation, the results can be integrated, for example, directly into the set of interdisciplinary mechatronic object data 8-1 to 8-5, or lead to changes to the set of interdisciplinary mechatronic object data 8-1 to 8-5.

Although the present invention has been described heretofore on the basis of preferred exemplary embodiments, it is not restricted to these, but may be modified in a wide variety of types and forms. In particular, the invention can be changed or modified in a large number of ways, without deviating from the core of the invention.

### LIST OF REFERENCE CHARACTERS

1 Apparatus

2 Data memory

3 Communications interface

4 Control facility

5-1-5-4 Service

6-1, 6-2 Server facility

7 Billing system

8-1-8-5 Object data

9 Data network

S1-S3 Method steps

What is claimed is:

1. An apparatus for the development and operation of at least one mechatronic installation that exhibits mechatronic units, with the apparatus comprising:
a data memory that stores interdisciplinary mechatronic object data relating to mechatronic units;
a communications interface configured to connect the apparatus to at least one data network; and
a control facility configured to:
identify at least one additional service relating to at least one of the mechatronic units of the mechatronic installation by an identification of the mechatronic unit stored in the interdisciplinary mechatronic object data,
load program code corresponding to a respective service into the data memory and implement it locally, and
call up at least one of the identified services by way of at least one of a protocol for the inter-process communication, a REST application interface, and a SOAP application interface.

2. The apparatus of claim 1,comprising at least one server facility configured to provide via the data network the additional services,
wherein at least one server facility comprises a central server facility configured to provide a schedule of the additional services.

3. The apparatus of claim 2,wherein at least one of the server facilities is configured to bill for the provision of the additional services with a billing system.

4. The apparatus of claim 1, wherein the additional services relating to the mechatronic units of the mechatronic installation exhibit services configured to support at least one of a development step of the mechatronic installation, maintenance of the mechatronic installation, and control of the mechatronic installation.

5. The apparatus of claim 1, comprising a user interface configured to provide a user a list of the available additional services or to allow a user to make a selection of additional services.

6. The apparatus of claim 5, wherein the control facility is configured to call up additional services selected by a user via the communications interface.

7. A method for the development and operation of at least one mechatronic installation that exhibits mechatronic units, the method comprising:
storing interdisciplinary mechatronic object data relating to the mechatronic units of the mechatronic installation;
identifying at least one additional service relating to at least one of the mechatronic units of the mechatronic installation by an identification of the mechatronic unit, stored in the interdisciplinary mechatronic object data;
performing the identified services, wherein program code corresponding to a respective service is stored and carried out locally, and wherein at least one of the identified services is performed using at least one of a protocol for an inter-process communication, a REST application interface, and a SOAP application interface.

8. The method of claim 7, wherein the additional services are provided on at least one server facility in the data network.

9. The method of claim 7, wherein a schedule of the additional services is provided on a server in the data network.

10. The method of claim 7, wherein the provision of the additional services is billed by way of a billing system.

11. The method of claim 7, wherein the additional services relating to the mechatronic units of the mechatronic installation exhibit services that support at least one of a development step of the mechatronic installation, maintenance of the mechatronic installation, and control of the mechatronic installation.

12. The method of claim 7, wherein a user is provided with a list of the additional services or the user is able to make a selection of additional services.

13. The method of claim 7, wherein the additional services selected by a user are called up by way of the data network.
